(19) United States
(12) Patent Application Publication
(10) Pub. No.: US 2006/0125373 A1
(43) Pub. Date: Jun. 15, 2006

(54) Double-sided luminous compound substrate

(75) Inventors: Biing-Nan Lin, Taichung City (TW); Cheng-Chung Lee, Taitung City (TW); Ming-Chun Hsiao, Zhudong Town (TW); Wei-Yi Lin, Tuku Town (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/068,964

(22) Filed: Mar. 2, 2005

(30) Foreign Application Priority Data
Dec. 10, 2004 (TW) 93138233

(51) Int. Cl. H01J 1/62

(52) U.S. Cl. 313/495

(57) ABSTRACT

A double-sided luminous compound substrate is disclosed. The double-sided luminous compound substrate comprises: a first transparent substrate, having a plurality of first conductors parallel disposed on a surface thereof, and a plurality of parallel-disposed second conductors overlapping the first conductors, each first conductor having a plurality of emitters equidistantly disposed thereon and electrically connected thereto; a second transparent substrate, disposed parallel to and opposite to the first transparent substrate, further comprising a fluorescence layer formed on the side facing the first transparent substrate; and a plurality of spacers, disposed between the first and second transparent substrates.

### 1. FIELD OF THE INVENTION

The invention is related to a compound substrate, and in particular to a double-sided luminous compound substrate with novel structure and material.

### 2. BACKGROUND OF THE INVENTION

A promising flat-panel display developed at 1980s is the field emission display (FED), which is a cathode ray tube (CRT) in disguise and is similar in operation to CRTs in that phosphor is excited by a stream of electrons traveling through a vacuum. The FED, however, is matrix-addressed, one entire row at a time with millions of electron-emitting cathodes. These emitters are a fraction of a millimeter (or up to 5 mm in the case of high-voltage FEDs) away from the phosphor screen, and they are produced by cold cathode emission. From the above description, it is noted that, unlike CRTs which generate hot cathode electrons by a cathode heater, FEDs have no cathode heater and discharge a stream of cold cathode electrons by cold cathode emission.

As shown in FIG. 1, a conventional FED 1 comprises a glass panel 11 and a glass substrate 18. A plurality of spacers 13 is disposed between the glass panel 11 and the glass substrate 18 to maintain a vacuum space therebetween. A fluorescence layer 12 and an electrode (not shown) are disposed on the glass panel 11 which is called anode panel. The method of forming the fluorescence layer is the same as those used in CRT or VFD. The glass substrate 18 is also called a cathode panel on which a cathode 17 is disposed. The cathode 17 has a plurality of emit tips 16. An insulation layer 15 is disposed between two emit tip 16. A gate 14 is disposed on the insulation layer 15 and has a plurality of openings 141, each corresponding to an emit tip 16.

In the FED, the cathode is formed by a field emission array (FEA) which is different from the CRT forming an electron beam by , focusing electrons from a heat electron source. The FEA is also different from VFD which has an planar electron source formed by several heat lines to become a real two-dimensional electron source. The FED employs an electrical field to attract electrons away from the cathode to the vacuum space, and the electrons are accelerated by the attraction of the anode to collide with the fluorescence screen for creating cathodoluminescence.

In the conventional FED, light can emit from only one side thereof, that is, only from the side of the anode panel since the light emitting from the anode panel to the cathode side is shielded by the poor transparence of the dielectric layer of the cathode panel.

In view of the above description, it is preferred to have a field emission device capable of emitting light from both topside and bottomside thereof.

### SUMMARY OF THE INVENTION

It is an object of the invention is to provide a double-sided luminous compound substrate employing a novel structure of transparent cathodes and gates for allowing light to be emitted from the topside and the bottomside thereof, and thus being used in a double-sided display as the backlight module thereof.

These and other valuable objects are achieved by means of a double-sided luminous compound substrate, comprising:
a first transparent substrate, having a plurality of first conductors parallel disposed on a surface thereof, and a plurality of parallel-disposed second conductors overlapping the first conductors, each first conductor having a plurality of emitters equidistantly disposed thereon and electrically connected thereto;
a second transparent substrate, disposed parallel to and opposite to the first transparent substrate, further comprising a fluorescence layer formed on the side facing the first transparent substrate; and
a plurality of spacers, disposed between the first and second transparent substrates.

Preferably, each first conductor is made of a transparent material such as indium tin oxide and the likes.

Preferably, the double-sided luminous compound substrate further comprises a transparent insulator disposed between the first conductors and the second conductors, where the first conductors and the second conductors are arranged perpendicular to each other.

Preferably, the first conductors and the second conductors are parallel and alternatively disposed.

Preferably, the double-sided luminous compound substrate further comprises a transparent conducting layer between the fluorescence layer and the second transparent substrate while the transparent conducting layer is made of a transparent material such as indium tin oxide and the likes.

In a preferred embodiment of the invention, the fluorescence layer is formed by a method selected from the group consisting of the screen print method, the electrophoresis method and the lithography method.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is cross section of a conventional FED;

FIG. 2 is a schematic view of a double-sided luminous display of the invention;

FIG. 3 is a partially enlarged view of FIG. 2 depicting a double-sided luminous compound substrate of the invention;

FIG. 4 is a top view of cathodes and gates of a conventional FED; and

FIG. 5 is a top view of cathodes and gates of a FED of the invention.

### DESCRIPTION OF THE PREFERRED EMBODIMENT

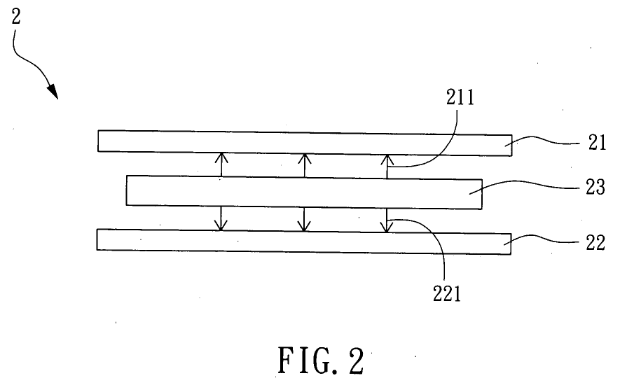

Referring to FIG. 2, a display 2 comprises an upper TFT liquid cell 21 and a lower TFT liquid cell 22. The double-sided luminous compound substrate 23 of the invention is disposed between the upper TFT liquid cell 21 and the lower TFT liquid cell 22 to serve as a backlight module for providing light to the upper TFT liquid cell 21 and the lower TFT liquid cell 22 simultaneously.

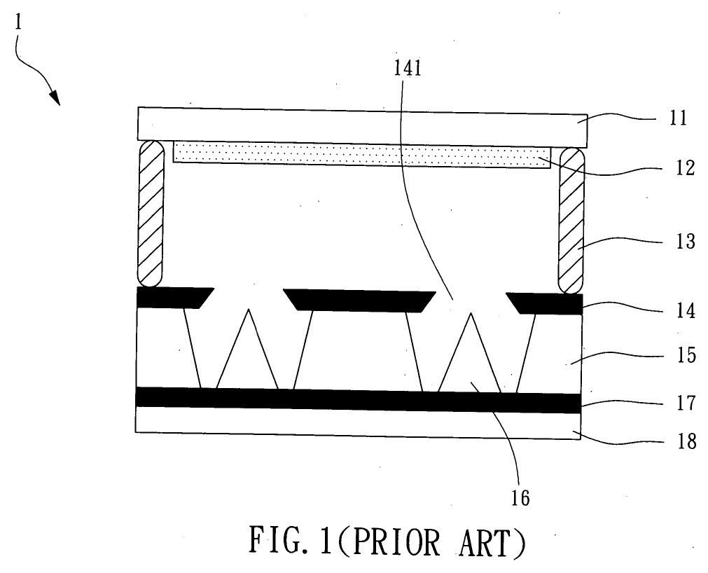

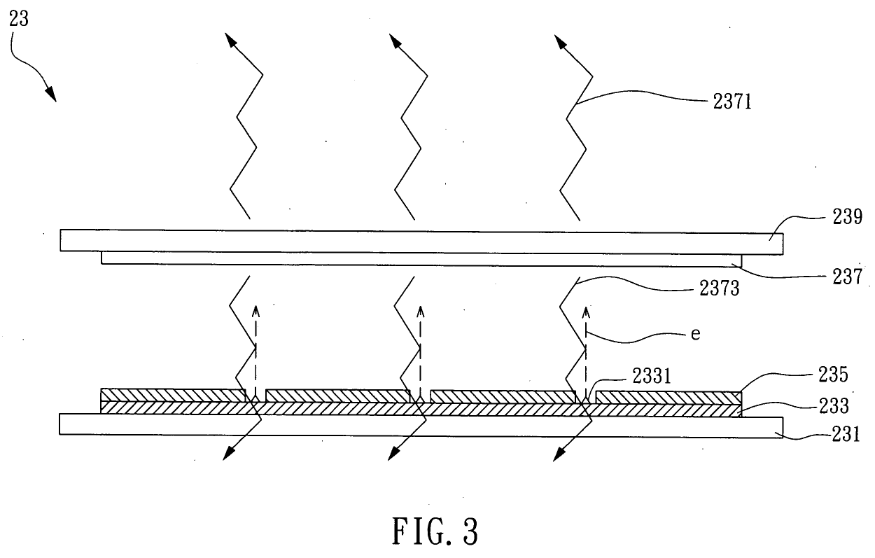

Referring to FIG. 3, the double-sided luminous compound substrate 23 is similar to the structure in FIG. 1. For simplicity, certain elements such as insulation layer and spacer are omitted. In FIG. 3, the double-sided luminous compound substrate comprises a first transparent substrate 231 made of transparent material such as glass. A plurality of first conductors 233 is disposed on the first transparent substrate 231. The first conductors 233 are made of metal or indium tin oxide (ITO). A plurality of second conductors 235 is disposed on the first conductors 233. In this structure, the first conductors 233 serve as cathodes, and the second conductors 235 serve as gates. The first conductor 233 further comprises a plurality of emit tips 2331 which is electrically conductive and electrically connected to the first conductors 233.

The double-sided luminous compound substrate further comprises a second transparent substrate 239 parallel to the first transparent substrate 231. A fluorescence layer 237 is formed on the side of the second transparent substrate 239 facing the first transparent substrate 231. The method of forming the fluorescence layer 237 can be one of the screen print method, the electrophoresis method and the lithography method. In this structure, a flat metal layer such as a aluminum layer or a ITO layer is formed on the second transparent substrate 239 by evaporation coating for electrical conduction. A plurality of spacers (not shown) is disposed between the first and second transparent substrates 231 and 239.

When actuated, a electrical field is imposed to the double-sided luminous compound substrate, electrons on the first conductors (cathode) 233 are attracted by the electrical field and launched from the emit tips 2331. The electrons away from the first conductors 233 are attracted and thus accelerated by the second transparent 239 to collide the fluorescence layer 237 to create cathode fluorescence 2371 and 2373.

The cathode fluorescence 2371 passes through the second transparent substrate 239 to display the image. In prior art, the first conductors 233, however, are most made of opaque metal, and the number of emit points are insufficient (the emit point is where the electrons launch, the boundary of the first conductors 233 and the second conductor 235) to cause the cathode fluorescence 2373 covered by the cathodes, and light cannot emit from the first transparent substrate 231.

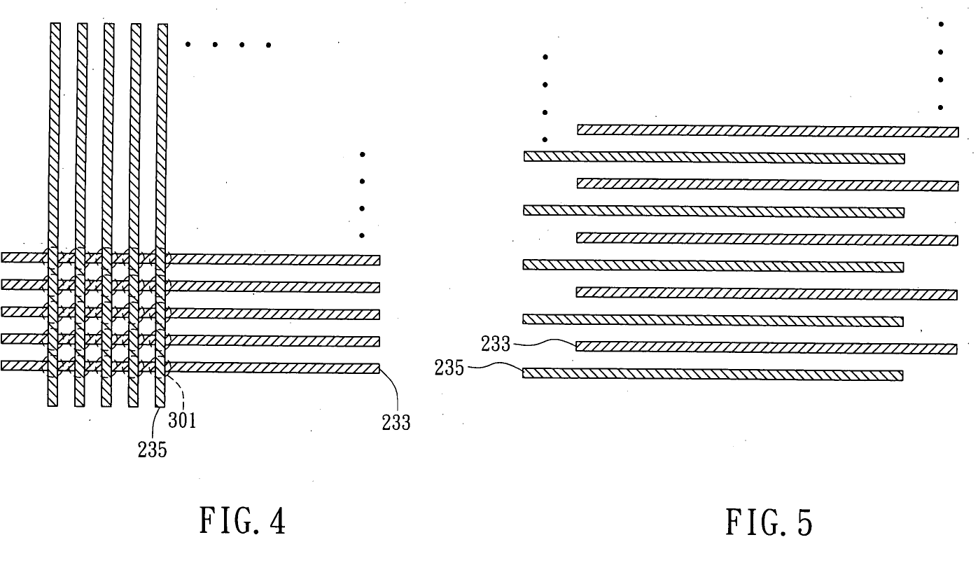

In the invention, the first conductors (cathode) 233 and the second conductors (gate) 235 have a novel structure as shown in FIG. 5. FIG. 4 is a top view of cathodes and gates of a conventional FED. In FIG. 4, the first conductors 233 and the second conductors 235 are perpendicular. In such structure, only the contact point of the first conductors 233 and the second conductors 235, i.e. region 301, can emit electrons (not shown). The emit efficiency of the structure is quite poor. In such structure, an insulation layer (not shown) must be disposed between the first conductor 233 and the second conductor 235. Therefore, when such structure is adapted in the invention, the first conductor 233 is made of transparent material such as ITO. The insulation layer is mad of material with high transparence, whereby the cathode fluorescence 2373 is allowed to pass through the first conductors 233.

Referring to FIG. 5, the first conductors 233 and the second conductors 235 are parallel and alternative disposed. In such structure, as the first conductors 233 contact the second conductors 235 completely, contact area is increased to increase number of emitted electrons. In such alternative arrangement, no insulation layer is needed between the first and second conductors 233 and 235, the cathode fluorescence 2373 can easily pass through the first conductors 233. The first conductors 233 can be made of metal. To obtain better emit efficiency, transparent material such as ITO can also be used.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A double-sided luminous compound substrate, comprising:
a first transparent substrate, having a plurality of first conductors parallel disposed on a surface thereof, and a plurality of parallel-disposed second conductors overlapping the first conductors, each first conductor having a plurality of emitters equidistantly disposed thereon and electrically connected thereto;
a second transparent substrate, disposed parallel to and opposite to the first transparent substrate, further comprising a fluorescence layer formed on the side facing the first transparent substrate; and
a plurality of spacers, disposed between the first and second transparent substrates.

2. The substrate as claimed in claim 1, wherein the first conductor is made of a transparent material.

3. The substrate as claimed in claim 2, wherein the transparent material is indium tin oxide.

4. The substrate as claimed in claim 2, further comprising a transparent insulator, disposed between the plural first conductors and the plural second conductors while the first conductors the second conductors are arranged perpendicular each other.

5. The substrate as claimed in claim 1, wherein the first conductors and the second conductors are parallel and alternatively disposed.

6. The substrate as claimed in claim 1, further comprising an aluminum layer formed on the fluorescence layer.

7. The substrate as claimed in claim 1, further comprising a transparent conducting layer, disposed between the fluorescence layer and the second transparent substrate.

8. The substrate as claimed in claim 7, wherein the transparent conducting layer is made of indium tin oxide.

9. The substrate as claimed in claim 7, wherein the fluorescence layer is formed by a means selected from the group consisting of the screen print method, the electrophoresis method and the lithography method.
